(19) United States
(12) Patent Application Publication
(10) Pub. No.: US 2015/0379520 A1
(43) Pub. Date: Dec. 31, 2015

(54) Identifying Discrepancies and Responsible Parties in a Customer Support System

(71) Applicant: International Business Machines Corporation, Armonk, NY (US)

(72) Inventors: Corville O. Allen, Morrisville, NC (US); Ramakrishna Boggarapu, Cary, NC (US); Ravi K. Muthukrishnan, Raleigh, NC (US); Walker L. Sherk, Raleigh, NC (US)

(21) Appl. No.: 14/319,055

(22) Filed: Jun. 30, 2014

(51) Int. Cl. G06Q 30/00; G06F 17/28

(52) U.S. Cl. CPC G06Q 30/016; G06F 17/28

(57) ABSTRACT

A mechanism is provided for improving customer satisfaction. Natural language processing (NLP) is utilized to identify information from a customer ticket that addresses a customer issue thereby forming one or more pieces of NLP identified information. Each piece of NLP identified information is analyzed to identify one or more responsible parties responsible for delays in addressing the customer issue. Responsive to identifying at least one responsible party responsible for at least one delay in addressing the customer issue, an indication flag is created for the responsible party. A notification of the at least one responsible party responsible for the at least one delay in addressing the customer issue is then sent.

### BACKGROUND

The present application relates generally to an improved data processing apparatus and method and more specifically to mechanisms for identifying discrepancies and responsible parties in a customer support system.

Customer support is a range of customer services to assist customers in making cost effective and correct use of a product. Customer support includes assistance in planning, installation, training, troubleshooting, maintenance, upgrading, and disposal of a product. In the process of customer support, various discrepancies may be formed between elements of the support structure and the customer. A discrepancy is a lack of compatibility or similarity between two or more facts. Thus, in customer support the customer may be experiencing one issue while one or more customer support personnel of the customer support team identify a completely different issue, thereby forming a discrepancy. These discrepancies may be observed after the customer's issue has been addressed. However, these discrepancies may negatively correlate with customer satisfaction. That is, while the customer's issue may have been resolved, discrepancies between elements of the support structure and the customer may pinpoint instances where the customer's issue may have been resolved more quickly or more efficiently and, thus, increase customer satisfaction.

### SUMMARY

In one illustrative embodiment, a method, in a data processing system, is provided for improving customer satisfaction. The illustrative embodiment utilizes natural language processing (NLP) to identify information from a customer ticket that addresses a customer issue thereby forming one or more pieces of NLP identified information. The illustrative embodiment analyzes each piece of NLP identified information to identify one or more responsible parties responsible for delays in addressing the customer issue. The illustrative embodiment creates an indication flag for the responsible party in response to identifying at least one responsible party responsible for at least one delay in addressing the customer issue. The illustrative embodiment then sends a notification of the at least one responsible party responsible for the at least one delay in addressing the customer issue.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a customer support data processing system in which the customer satisfaction improvement mechanism may be implemented in accordance with the illustrative embodiments; and

FIG. 4 depicts an exemplary operation performed by a customer satisfaction improvement mechanism in accordance with an illustrative embodiment.

### DETAILED DESCRIPTION

As discussed above, in the process of customer support, various discrepancies, e.g., compatibility or similarity issues between two or more facts provided by the customer and customer support personnel or between two or more facts provided by two or more customer support personnel may be formed between elements of a support structure and a customer. While ultimately a resolution may be identified that addresses the customer's issue, the discrepancies between elements of the support structure and the customer may pinpoint instances where the customer's issue may have been resolved more quickly or more efficiently and, thus, increase customer satisfaction. Therefore, the identified discrepancies may negatively correlate with customer satisfaction.

To improve customer satisfaction, the illustrative embodiments provide a customer satisfaction improvement mechanism that identifies such discrepancies and responsible parties in a customer support system. That is, when the customer has an issue and contacts customer support, an initial customer support technician creates a problem management record or ticket, which identifies the customer, customer contact information, the customer's issue, and/or additional information pertinent to identifying the originator of the problem management record/ticket (hereafter referred to as the “ticket”) and the particular problem encountered. Based on the information provided by the customer, the initial customer support technician forwards the ticket to an initial support team by, for example, changing a code field that causes the ticket to be transferred to the initial support team. In addition to being assigned to the initial support team, the ticket may also be assigned to a particular support technician in the initial support team. The initial support team and/or particular support technician may analyze the issue and either address the issue or identify that the issue is not handled by the particular support technician or initial support team and forward the ticket to either another support technician of the initial support team or another support team altogether. In forwarding the ticket, the particular support technician and/or the initial support team may add statements to the ticket, change a code field indicating a next support technician or a next support team, or the like. This process may continue until an appropriate support team is reached and the issue is resolved for the customer. However, each time the ticket is transferred, more time is required in analyzing the issue by the next support technician or the next support team and, thus, customer satisfaction may decrease.

The customer satisfaction improvement mechanism of the illustrative embodiments monitors customer tickets as soon as each ticket is opened and thereafter. The customer satisfaction improvement mechanism utilizes natural language processing (NLP) to identify information in the statements, such as the issue the customer is experiencing, notations added by each support technician, or other comments made by anyone who has addressed the customer issue, code field changes, and/or other information pertinent to how the customer issues are being addressed, of the ticket provided by the customer and the various support teams and/or support technicians on the support team about a customer's issue. These NLP mechanisms may take many different forms but generally operate to parse and analyze unstructured or structured textual content of the ticket in many different ways to identify semantic and syntactic elements within the text to provide an understanding of the content, its organization, and how it relates to various types of subject matter of one or more domains of subject matter. The results generated by the operation of an NLP mechanism, e.g., a collection of one or more NLP algorithms, is generally referred to herein as NLP identified information and may include, but is not limited to, parts of speech, keywords, sentence structure information, document structure information, focus, lexical answer type, synonyms, antonyms, etc. NLP mechanisms are generally known in the art and any known or later developed NLP mechanism may be used to achieve the processes of generating NLP identified information.

The customer satisfaction improvement mechanism utilizes NLP mechanisms to analyze ticket content and identify instance indications in the ticket content that signify transfers of the ticket between support technicians on a single support team as well as transfers of the ticket between support teams throughout the life of the ticket. Additionally, the customer satisfaction improvement mechanism utilizes NLP mechanisms to identify information in the content of the ticket indicative of potential delays, conflicts, or other problems encountered in addressing the customer issue by and between support personnel during the processing of the ticket as well as the ultimate resolution of the ticket, e.g., causes for the ticket to be transferred, negations of one or more statements by one or more subsequent statements made by support personnel, a description of the ultimate resolution of the ticket, or the like.

Further, the customer satisfaction improvement mechanism may utilize previous NLP identified information from NLP analysis of previous tickets for the customer of the current ticket as well as other customers, e.g., information in the content of the previous ticket indicative of potential delays, conflicts, or other problems encountered in addressing the customer issue by and between support personnel during the processing of the previous ticket as well as the ultimate resolution of the previous ticket, e.g., causes for the previous ticket to be transferred, negations of one or more statements by one or more subsequent statements made by support personnel, a description of the ultimate resolution of the previous ticket, or the like, to identify key ticket elements such as customer callbacks, previous ticket transfers, or the like indicative of reoccurring delays, conflicts, or other problems encountered in addressing previous customer issues.

The customer satisfaction improvement mechanism then utilizes NLP identified information to identify one or more responsible parties responsible for delays, conflicts, or other problems encountered in addressing the customer issue based on discrepancies in the NLP identified information, such as an initial incorrect forwarding of the ticket to an incorrect support technician or support team, incorrect assessment of the issue by a support team, an underlying resource issue causing the customer's issue, or the like. That is, the NLP mechanism analyzes the NLP identified information to discrepancies between two or more facts provided by the customer and customer support personnel or between two or more facts provided by two or more customer support personnel. Then, based on the resolution of the ticket, the NLP mechanism identifies which statements were incorrect or misleading and, based on technician or team identification codes associated with those incorrect or misleading statements, and, thus, identify one or more responsible parties responsible for delays, conflicts, or other problems encountered. Once the one or more responsible parties are identified, the customer satisfaction improvement mechanism may alert one or more administrators of the one or more responsible parties as to the issues identified with the resolution of the customer's ticket, in order to improve customer satisfaction for subsequent customer issues and alleviate or avoid customer escalations of issues to administrative levels. In order that not every discrepancy is escalated to an administrator, the customer satisfaction improvement mechanism may flag each discrepancy and escalate an issue to an administrator only when the number of flags for a particular support technician or particular support team exceeds a predetermined threshold over a plurality of tickets.

In accordance with the illustrative embodiments, a “mechanism,” as used herein, may be an implementation of the functions or aspects of the illustrative embodiments in the form of an apparatus, a procedure, or a computer program product. The mechanisms described herein may be implemented as specialized hardware, software executing on general purpose hardware, software instructions stored on a medium such that the instructions are readily executable by specialized or general purpose hardware, a procedure or method for executing the functions, or a combination of the above.

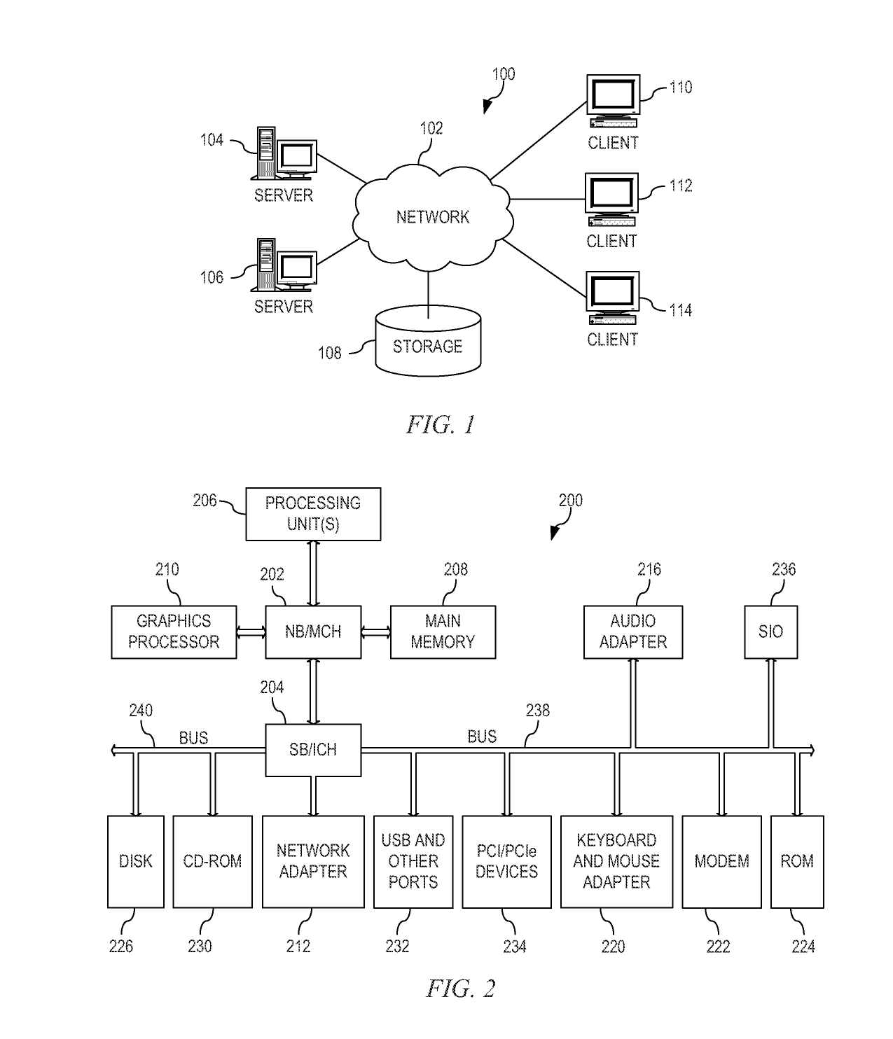

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System P® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

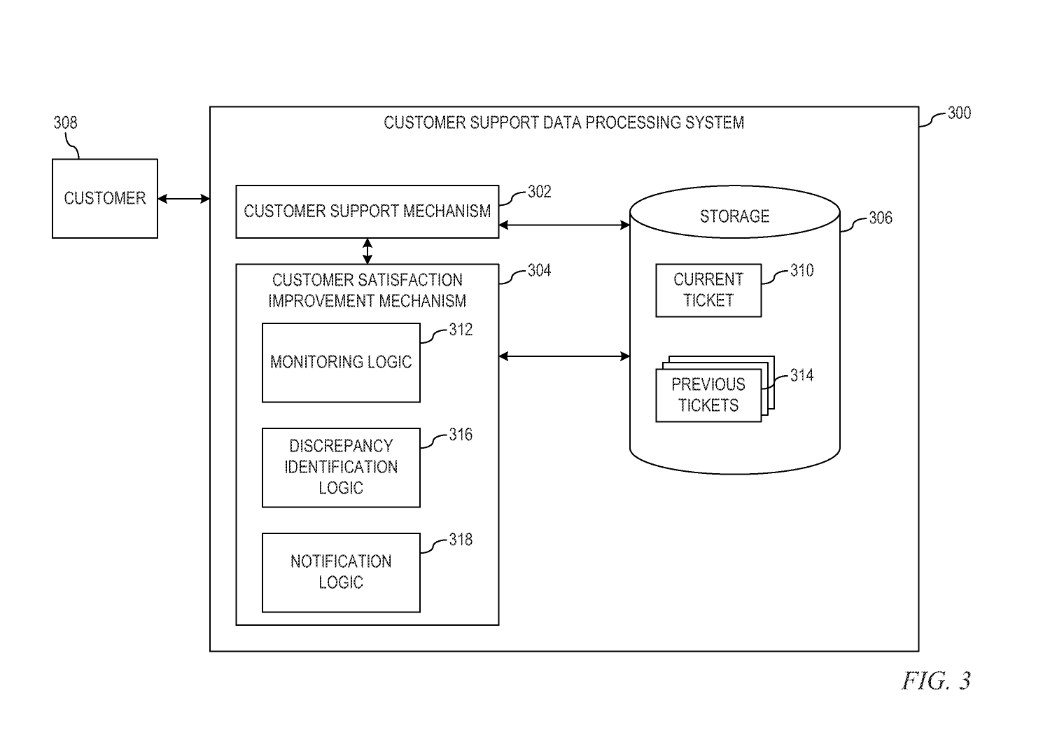

FIG. 3 depicts a customer support data processing system in which the customer satisfaction improvement mechanism may be implemented in accordance with the illustrative embodiments. Customer support data processing system 300 comprises customer support mechanism 302, customer satisfaction improvement mechanism 304, and storage 306. In customer support data processing system 300, when customer 308 has an issue, the customer support data processing system 300 provides a mechanism through which customers may report problems or issues encountered during their operation or interaction with a product or service, e.g., a hardware and/or software product, a service provided by an entity for which the system 300 is utilized to handle customer issues, or the like. Such problems may include an inability to access data, an inability to execute an application, or the like. Thus, when a customer encounters a problem or issue with the product or service, the customer may interact with customer support data processing system 300 to report this problem and request assistance in resolving the problem by creating a problem management record or ticket. Either interactively or through an initial customer support technician, customer support data processing system 300 creates a problem management record or ticket 310 (hereafter “ticket” 310) via customer support mechanism 302. Ticket 310 comprises customer information, such as customer contact information, a description of the customer's issue, and other pertinent information for identifying the customer and the issue being reported by the customer. Once the ticket has been created and information associated with the customer and the customer's issue recorded in ticket 310, customer support mechanism 302 stores ticket 310 in storage 306.

Once ticket 310 is created and stored, either automatically or through the initial customer support technician, customer support mechanism 302 notifies an initial support team and/or a particular individual within the support team of the existence of the ticket 310 and its need to be resolved by, for example, changing a code field that causes the ticket 310 to be transferred to the initial support team and/or particular support technician within the support team. Customer support mechanism 302 accomplishes the transfer of ticket 310 by analyzing the issue reported by the customer, identifying one or more particular aspects of the issue, and changing an assignment code field associated with ticket 310 that sends notification to the support technician or support team informing them of the ticket entry and requiring them to access, address, and/or and resolve ticket 310.

The initial support team and/or particular support technician may analyze the issue and either address the issue or identify that the issue is not handled by the particular support technician or initial support team and forward the ticket 310 to either another member of the initial support team or another support team altogether. In forwarding the ticket 310, the particular support technician and/or the initial support team may add statements, such as the issue the customer is experiencing, notations added by each support technician, or other comments made by anyone who has addressed the customer issue to the ticket 310, change a code field indicating the next support team and/or particular support technician that should handle the resolution of the issue associated with the ticket 310, or the like. This process may continue until an appropriate support team or support technician is reached and the issue is resolved for the customer. However, each time the ticket 310 is transferred, more time is required in analyzing the issue by the next support team or support team member and, thus, customer satisfaction may decrease due to delays, conflicts, or other problems encountered in addressing the customer issue.

In accordance with illustrative embodiments, in order to identify one or more responsible parties responsible for delays, conflicts, or other problems encountered in addressing the customer issue, monitoring logic 312 gathers information from ticket 310 utilizing natural language processing (NLP). This information may come from statements made by various support personnel during the handling of the ticket 310, from transfer codes associated with the transfer of ticket 310 between support technicians on a single support team as well as transfers of the ticket between support teams, or the like. Therefore, monitoring logic 312, within customer satisfaction improvement mechanism 304, monitors ticket 310 as soon as ticket 310 is opened and thereafter. Monitoring logic 312 utilizes natural language processing (NLP) mechanisms, e.g., NLP algorithms executed on general purpose hardware and/or dedicated NLP hardware, to identify information in statements, code field changes, or the like, of ticket 310 provided by the various support teams and/or support technicians on the support team about a customer's issue in order to identify one or more responsible parties responsible for delays, conflicts, or other problems encountered in addressing the customer issue. Natural language processing (NLP) is the understanding of human languages by a computer. This means that the computer should be able to use a human language to accept the kind of data the computer normally processes. In dealing with a written language, one of the biggest problems is ambiguity: incomplete information, contextual information, etc. Thus, most sentences are ambiguous. In accordance with the illustrative embodiments, the NLP mechanisms perform one or more of morphological analysis, syntactical analysis or parsing, semantic analysis, or pragmatic analysis. In morphological analysis, the NLP mechanisms analyze individual words and punctuation to determine the part of speech the words with or without punctuation are (or could be). In syntactical analysis or parsing, the NLP mechanisms determine the sentence constituents and the hierarchical sentence structure, using word order, number agreement, case agreement, and/or grammars. In semantic analysis, the NLP mechanisms determine the meaning of the sentence. With many sentences being ambiguous, the NLP mechanisms look to the specific actions being performed on specific objects. Finally, in pragmatic analysis, the NLP mechanisms determine an actual meaning and intention in context (of speaker, of previous sentence, etc.). The NLP mechanisms handle pronouns such as “it,” to identify implicit meanings To handle all this, the NLP mechanisms keep track of the focus of the dialog, a model of each participant's beliefs, as well as knowing the rules and goals of dialog.

Thus, in accordance with the illustrative embodiments, NLP identified information is results information identified utilizing natural language processing (NLP) through morphological analysis, syntactical analysis or parsing, semantic analysis, or pragmatic analysis thereby identifying parts of speech, such as nouns, pronouns, verbs, adverbs, adjectives, prepositions, conjunctions, interjections, or the like, prepositional phrases, clauses, indefinite terminology, or the like, sentence constituents and the hierarchical sentence structure, sentence meaning, actual meaning, intention in context, or the like.

As an example of the NLP operations performed by monitoring logic 312 on statements in ticket 310, there may be statements addressing the customer issue from various support technicians and/or support teams (as identified by, for example, the four-digit numerical code associated with the statement) such as:
(0033) Production application system failed to perform as expected because the database failed.
(0042) Production application logs do not contain any failure logs or error messages. So, the failure may be because of other products that are running in your environment.
(0027) Customer may have network issue as we do not see any failures in this application.

In the first statement, the NLP operations identifies the term “system” as a noun and subject of the sentence and the terms “production” and “application” as adjectives that are modifying the subject thereby identifying which system from numerous existing systems. Additionally, the NLP operations identify the term “failed” as a verb and the action that occurred. The NLP operations further identifies the prepositional phrase “to perform as expected” as indicating how the production application system failed. Finally, the NLP operations identify the clause “because the database failed” as indicating the cause for the failure.

In the first sentence of the second statement, the NLP operations identifies the term “log” as a noun and subject of the sentence and the term “production” as an adjective that modifies the subject thereby identifies which log from numerous existing logs. Additionally, the NLP operations identify the phrase “do not contain” as a verb phrase and the action that occurred. Finally, the NLP operations identifies the phrase “any failure logs or error message” as the object of the verb phrase indicating what the productions application logs do not contain. However, in order to identify the responsible party in the second statement, the NLP mechanisms have to analyze the second sentence of the second statement. Thus, the NLP operations identify the term “failure” as a noun and subject and the phrase “may be” as a verb phrase. Further, the NLP operations identify the clause “because of other products that are running in your environment” as indicating the cause for the failure, i.e. the responsible party is other products. However, the term “may” is an indefinite term and the term “other products” as vague.

In the third statement, the NLP operations identify the term “customer” as a noun and subject of the sentence and the phrase “may have” as a verb phrase indicating the action that occurred. The NLP operations identify the phrase “network issue” as the object of the verb phrase and the clause “as we do not see any failures in this application” as pragmatically indicating no failure in the application. However, as with the second statement, the NLP operations also identify the term “may” as an indefinite term.

Therefore, monitoring logic 312 identifies, within such statements of ticket 310, parts of speech, such as nouns, pronouns, verbs, adverbs, adjectives, prepositions, conjunctions, interjections, or the like, prepositional phrases, clauses, indefinite terminology, or the like, which results in NLP identified information. More specifically, monitoring logic 312 uses NLP to identify NLP identified information, such as:

nouns or pronouns that refer to products,

verbs and adverbs associated with the nouns or pronouns,

specific verbs or adverbs, such as caused by, problem, issue, or the like,

negative connotations associated with the identified nouns or pronouns,

source of statement via a source code associated with statement, or

the like.

Monitoring logic 312 also uses NLP to identify key ticket elements where a ticket has been transferred between support technicians on a single support team as well as transfers of the ticket between support teams throughout the life of the ticket. Monitoring logic 312 may use NLP to identify ticket transfers based on source code field changes associated with the statements. Additionally, monitoring logic 312 utilizes NLP to identify key ticket elements such as causes for the ticket to be transferred, for example, a production application support technician providing a statement that the production application was, at the time the customer issue occurred, working properly; negations of one or more statements by one or more subsequent statements, for example, one statement by one indicating a possible network issue when another statement indicating a data base failure; an ultimate resolution of the ticket, for example, a statement indicating that the production application failed because the database failed, or the like. Further, monitoring logic 312 may utilize previous NLP identified information associated with previous tickets 314 of the same customer in storage 306, such as customer callbacks, previous ticket transfers, previous causes for the customer′ issues, previous resolutions, or the like, to identify reoccurring delays, conflicts, or other problems encountered in addressing previous customer issues and, thus, one or more support technicians or support teams responsible for the delays, conflicts, or other.

As monitoring logic 312 gathers the NLP identified information, discrepancy identification logic 316 within customer satisfaction improvement mechanism 304 utilizes the NLP identified information to identify one or more responsible parties responsible for delays, conflicts, or other problems encountered in addressing the customer issue based on discrepancies, i.e. a lack of compatibility or similarity between two or more facts, in the NLP identified information, such as:

an initial incorrect forwarding of the ticket,

incorrect assessment of the issue by a support team,

an underlying resource issue caused the customer's issue, or

the like.

For example, with regard to the first statement above, utilizing the subject of “system”, the adjectives of “production” and “application” as identifying the particular system, the term “failed” as the action that occurred, and the clause “because the database failed” that indicates the cause for the failure, discrepancy identification logic 316 identifies that at least the support team of the database is the responsible party for the failure. However, utilizing the second and third statements, discrepancy identification logic 316 identifies that the support technician or support team responsible for those statements that include the terms “may” and “other products” are, in some part, parties responsible for delays, conflicts, or other problems encountered in addressing the customer issue as their analysis is vague, indefinite, dismissive, or the like.

Therefore, as discrepancy identification logic 316 identifies each discrepancy, discrepancy identification logic 316 creates an identification flag value stored in a memory, register, or the like, based on, for example, the four-digit numerical code associated with the statement of the support team or support technician that is responsible for the statement where the discrepancy occurred. Once all the discrepancies have been identified in the NLP identified information, discrepancy identification logic 316 determines whether a total of identification flags for one or more support technicians or support teams exceeds an associated predetermined threshold for that support technician or support team over a plurality of tickets. If a total of identification flags for one or more support technicians or support teams exceeds a predetermined threshold for that support technician or support team over a plurality of tickets, notification logic 318 within customer satisfaction improvement mechanism 304 sends a notification to one or more administrators of the one or more responsible support technicians and/or support teams as to the issues with resolution of ticket 310, as well as any previous tickets, in order to improve customer satisfaction for subsequent customer issues and alleviate or avoid future customer escalations so that the one or more administrators may take action to improve customer satisfaction. That is, the notification sent by notification logic 318 includes an identification of the support technician or support team; an identification of one or more tickets that caused the notification to be issued; the discrepancy associated with each; the one or more tickets causing the support technician or support team to be flagged; or the like. Examples of actions that the one or more administrators may take to improve customer satisfaction may include, but are not limited to, improve initial support technician analysis of the ticket so that a transfer of the ticket is more accurately performed, improve statements made by support technicians to exclude vague or indefinite terms, or the like. Furthermore, in order to alleviate any customer concerns as to improvement in customer satisfaction, notification logic 318 may also send one or more of the flagged discrepancies to a customer representative, so that the customer representative may contact the customer and let the customer know that improvements are being made to the customer support system in order to improve customer satisfaction for subsequent customer issues and alleviate or avoid customer escalations.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

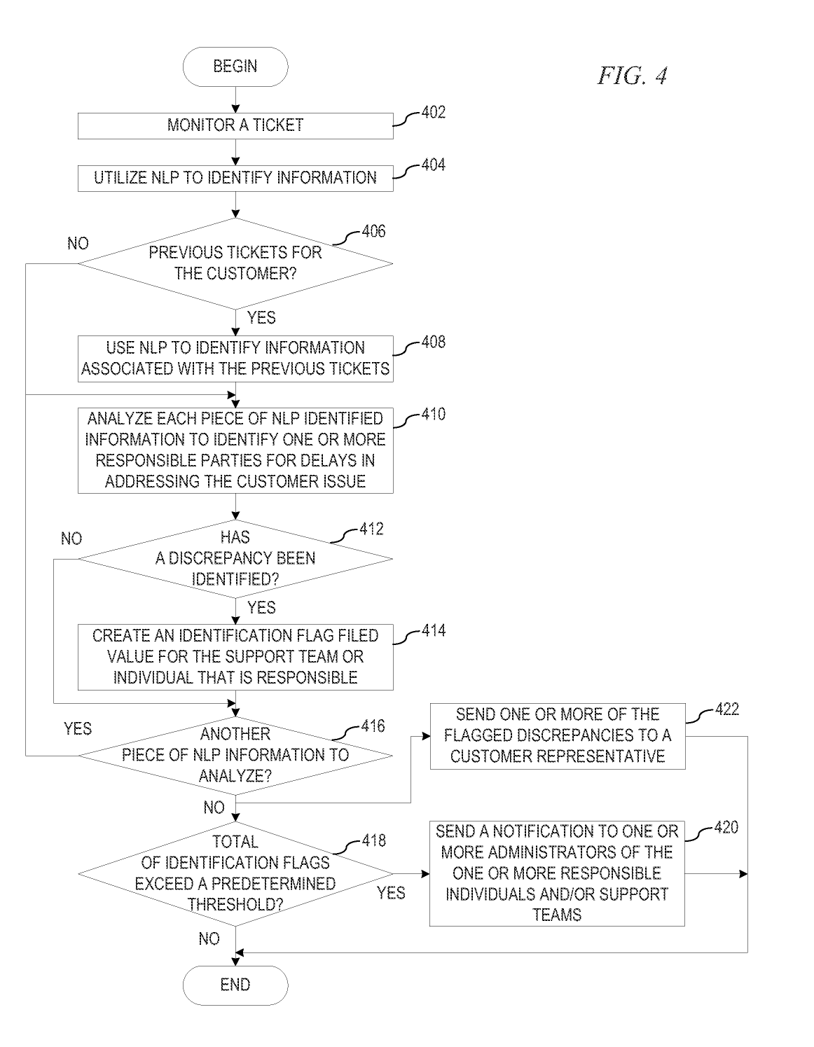

FIG. 4 depicts an exemplary operation performed by a customer satisfaction improvement mechanism in accordance with an illustrative embodiment. As the operation begins, the customer satisfaction improvement mechanism monitors a ticket that has been opened for a customer issue (step 402). The customer satisfaction improvement mechanism utilizes natural language processing (NLP) to identify information from statements made by various support personnel during the handling of the ticket, from transfer codes associated with the transfer of the ticket between support technicians on a single support team as well as transfers of the ticket between support teams, or the like, of the ticket provided by the various support teams and/or support technicians on the support team about a customer's issue (step 404). That is, the customer satisfaction improvement mechanism identifies, within such parts of speech, such as nouns, pronouns, verbs, adverbs, adjectives, prepositions, conjunctions, interjections, or the like, prepositional phrases, clauses, indefinite terminology, or the like, sentence constituents and the hierarchical sentence structure, sentence meaning, actual meaning, intention in context, or the like.

The customer satisfaction improvement mechanism also uses NLP to identify information such as key ticket elements where a ticket has been transferred between support technicians on a single support team as well as transfers of the ticket between support teams throughout the life of the ticket. The customer satisfaction improvement mechanism may also use NLP to identify information such as ticket transfers based on source code field changes associated with the statements. Additionally, the customer satisfaction improvement mechanism utilizes NLP to identify information such as key ticket elements such as causes for the ticket to be transferred, negations of one or more statements by one or more subsequent statements, an ultimate resolution of the ticket, or the like.

The customer satisfaction improvement mechanism also determines whether there are previous tickets that have been resolved for the customer (step 406). If at step 406 customer satisfaction improvement mechanism determines there are previous tickets that have been resolved for the customer, the customer satisfaction improvement mechanism uses NLP to identify information associated with the previous tickets (step 408), such as customer callbacks, previous ticket transfers, previous causes for the customer′ issues, previous resolutions, or the like, to identify reoccurring delays, conflicts, or other problems encountered in addressing previous customer issues and, thus, one or more support technicians or support teams responsible for the delays, conflicts, or other. From step 408 or if at step 406 the customer satisfaction improvement mechanism determines that there are no previous tickets that have been resolved for the customer, the customer satisfaction improvement mechanism analyzes each piece of NLP identified information to identify one or more responsible parties responsible for delays, conflicts, or other problems encountered in addressing the customer issue (step 410), such as:

an initial incorrect forwarding of the ticket,

incorrect assessment of the issue by a support team,

an underlying resource issue caused the customer's issue, or

the like.

For each piece of NLP identified information, the customer satisfaction improvement mechanism determines whether a discrepancy exists (step 412). If at step 412 the customer satisfaction improvement mechanism identifies a discrepancy, the customer satisfaction improvement mechanism creates an identification flag value stored in a memory, register, or the like, based on, for example, the four-digit numerical code associated with the statement of the support team or support technician that is responsible for the statement where the discrepancy occurred (step 414). From step 414 or if at step 412 the customer satisfaction improvement mechanism fails to identify a discrepancy, the customer satisfaction improvement mechanism determines whether there is another piece of NLP information to analyze (step 416).

If at step 416 there is another piece of NLP information to analyze, the operation returns to step 410. If at step 416 there fails to be another piece of NLP information to analyze, the customer satisfaction improvement mechanism determines whether a total of identification flags for one or more support technicians or support teams exceeds a predetermined threshold (step 418). If at step 418 the customer satisfaction improvement mechanism determines that a total of identification flags for one or more support technicians or support teams exceeds a predetermined threshold, the customer satisfaction improvement mechanism sends a notification to one or more administrators of the one or more responsible support technicians and/or support teams as to the issues with resolution of the ticket (step 420) in order to improve customer satisfaction for subsequent customer issues and alleviate or avoid customer escalations, with the operation ending thereafter.

If at step 418 the customer satisfaction improvement mechanism determines that a total of identification flags for one or more support technicians or support teams fails to exceed the predetermined threshold, the operation ends. As an optional step, if at step 416 there fails to be another piece of NLP information to analyze, the customer satisfaction improvement mechanism sends one or more of the flagged discrepancies to a customer representative (step 422), so that the customer representative may contact the customer and let the customer know that improvements are being made to the customer support system in order to improve customer satisfaction for subsequent customer issues and alleviate or avoid customer escalations, with the operation ending thereafter. The notification sent includes an identification of the support technician or support team; an identification of one or more tickets that caused the notification to be issued; the discrepancy associated with the one or more tickets causing the support technician or support team to be flagged; or the like. Examples of actions that the one or more administrators may take to improve customer satisfaction may include, but are not limited to, improving initial support technician analysis of the ticket so that a transfer of the ticket is more accurately performed, improving statements made by support technicians to exclude vague or indefinite terms, or the like.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for identifying discrepancies and responsible parties in a customer support system. The customer satisfaction improvement mechanism monitors customer tickets as soon as each ticket is opened and thereafter. The customer satisfaction improvement mechanism utilizes natural language processing (NLP) to identify information associated with the ticket and, using the NLP identified information, the customer satisfaction improvement mechanism identifies one or more responsible parties responsible for a delay, conflict, or other problem encountered in addressing the customer issue based on discrepancies in the NLP identified information. Once the one or more responsible parties are identified, the customer satisfaction improvement mechanism may alert one or more administrators of the one or more responsible parties as to the issues with resolution of the customer's ticket in order to improve customer satisfaction for subsequent customer issues and alleviate or avoid customer escalations.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for improving customer satisfaction, the method comprising:
utilizing, by a processor in the data processing system, natural language processing (NLP) to identify information from a customer ticket that addresses a customer issue thereby forming one or more pieces of NLP identified information;
analyzing, by the processor, each piece of NLP identified information to identify one or more responsible parties responsible for delays in addressing the customer issue;
responsive to identifying at least one responsible party responsible for at least one delay in addressing the customer issue, creating, by the processor, an indication flag for the responsible party; and
sending, by the processor, a notification of the at least one responsible party responsible for the at least one delay in addressing the customer issue.

2. The method of claim 1, further comprising:
identifying, by the processor, one or more previous customer tickets for the customer;
utilizing, by the processor, NLP to identify historical information from the previous customer tickets, wherein the historical information is at least one of customer callbacks, previous ticket transfers, previous causes for the customer issues, or previous resolutions; and
utilizing, by the processor, the historical information in analyzing each piece of NLP identified information to identify the one or more responsible parties responsible for delays in addressing the customer issue.

3. The method of claim 1, further comprising:
for each of the at least one responsible parties responsible for the at least one delay in addressing the customer issue:
prior to sending the notification of the at least one responsible party responsible for the at least one delay in addressing the customer issue, determining, by the processor, a total of the identification flags for the at least one responsible party responsible for the at least one delay in addressing the customer issue exceeds a predetermined threshold; and
responsive to the total of the identification flags for the at least one responsible party responsible for the at least one delay in addressing the customer issue exceeding the predetermined threshold, sending, by the processor, the notification of the at least one responsible party responsible for the at least one delay in addressing the customer issue.

4. The method of claim 1, wherein the notification is sent to at least one of an administrator for the at least one responsible party responsible for the at least one delay in addressing the customer issue or a customer representative of the customer.

5. The method of claim 1, wherein the information is from at least one support team or at least one support technician on the at least one support team.

6. The method of claim 1, wherein the NLP identifies, within statements associated with the customer ticket, parts of speech, and wherein the parts of speech are at least one of nouns, pronouns, verbs, adverbs, adjectives, prepositions, conjunctions, or interjections.

7. The method of claim 1, wherein the NLP identifies, within statements associated with the customer ticket grammar usages and wherein the grammar usages are at least one of nouns or pronouns that refer to products, verbs and adverbs associated with the nouns or pronouns, specific verbs or adverbs, negative connotations associated with the identified nouns or pronouns, or source of statement via a source code associated with statement.

8. The method of claim 1, wherein the NLP identifies key ticket elements where the customer ticket is transferred between support technicians on a single support team or between support teams and wherein transfers of the customer ticket are identified using source code field changes.

9. The method of claim 1, wherein the NLP identifies one or more of a cause for the customer ticket to be transferred, negations of one or more statements by one or more subsequent statements, or an ultimate resolution of the ticket.

10. The method of claim 1, wherein analyzing each piece of NLP identified information to identify one or more responsible parties responsible for delays in addressing the customer issue is based on identifying at least one discrepancy and wherein the at least one discrepancy is at least one of an initial incorrect forwarding of the ticket, an incorrect assessment of the issue by a support team, or an underlying resource issue caused by the customer's issue.

11. A computer program product comprising a computer readable storage medium having a computer readable program stored therein, wherein the computer readable program, when executed on a computing device, causes the computing device to:
utilize natural language processing (NLP) to identify information from a customer ticket that addresses a customer issue thereby forming one or more pieces of NLP identified information;
analyze each piece of NLP identified information to identify one or more responsible parties responsible for delays in addressing the customer issue;
responsive to identifying at least one responsible party responsible for at least one delay in addressing the customer issue, create an indication flag for the responsible party; and
send a notification of the at least one responsible party responsible for the at least one delay in addressing the customer issue.

12. The computer program product of claim 11, wherein the computer readable program further causes the computing device to:
identify one or more previous customer tickets for the customer;
utilize NLP to identify historical information from the previous customer tickets, wherein the historical information is at least one of customer callbacks, previous ticket transfers, previous causes for the customer issues, or previous resolutions; and
utilize the historical information in analyzing each piece of NLP identified information to identify the one or more responsible parties responsible for delays in addressing the customer issue.

13. The computer program product of claim 11, wherein the computer readable program further causes the computing device to:
for each of the at least one responsible parties responsible for the at least one delay in addressing the customer issue:
prior to sending the notification of the at least one responsible party responsible for the at least one delay in addressing the customer issue, determine a total of the identification flags for the at least one responsible party responsible for the at least one delay in addressing the customer issue exceeds a predetermined threshold; and
responsive to the total of the identification flags for the at least one responsible party responsible for the at least one delay in addressing the customer issue exceeding the predetermined threshold, send the notification of the at least one responsible party responsible for the at least one delay in addressing the customer issue.

14. The computer program product of claim 11, wherein the notification is sent to at least one of an administrator for the at least one responsible party responsible for the at least one delay in addressing the customer issue or a customer representative of the customer.

15. The computer program product of claim 11, wherein the information is from at least one support team or at least one support technician on the at least one support team.

16. An apparatus comprising:
a processor; and
a memory coupled to the processor, wherein the memory comprises instructions which, when executed by the processor, cause the processor to:
utilize natural language processing (NLP) to identify information from a customer ticket that addresses a customer issue thereby forming one or more pieces of NLP identified information;
analyze each piece of NLP identified information to identify one or more responsible parties responsible for delays in addressing the customer issue;
responsive to identifying at least one responsible party responsible for at least one delay in addressing the customer issue, create an indication flag for the responsible party; and
send a notification of the at least one responsible party responsible for the at least one delay in addressing the customer issue.

17. The apparatus of claim 11, wherein the instructions further cause the processor to:
identify one or more previous customer tickets for the customer;
utilize NLP to identify historical information from the previous customer tickets, wherein the historical information is at least one of customer callbacks, previous ticket transfers, previous causes for the customer issues, or previous resolutions; and
utilize the historical information in analyzing each piece of NLP identified information to identify the one or more responsible parties responsible for delays in addressing the customer issue.

18. The apparatus of claim 11, wherein the instructions further cause the processor to:
for each of the at least one responsible parties responsible for the at least one delay in addressing the customer issue:
prior to sending the notification of the at least one responsible party responsible for the at least one delay in addressing the customer issue, determine a total of the identification flags for the at least one responsible party responsible for the at least one delay in addressing the customer issue exceeds a predetermined threshold; and
responsive to the total of the identification flags for the at least one responsible party responsible for the at least one delay in addressing the customer issue exceeding the predetermined threshold, send the notification of the at least one responsible party responsible for the at least one delay in addressing the customer issue.

19. The apparatus of claim 11, wherein the notification is sent to at least one of an administrator for the at least one responsible party responsible for the at least one delay in addressing the customer issue or a customer representative of the customer.

20. The apparatus of claim 11, wherein the information is from at least one support team or at least one support technician on the at least one support team.
